(19) United States
(12) Patent Application Publication
(10) Pub. No.: US 2005/0058872 A1
(43) Pub. Date: Mar. 17, 2005

(54) Connection assembly for promoting electrical isolation

(76) Inventors: Scott C. Blanchet, Monroe, CT (US); Dana A. Kelley, New Milford, CT (US); Mohammad Farooque, Danbury, CT (US); Richard Way, Watertown, CT (US)

Correspondence Address: COWAN LIEBOWITZ & LATMAN, P.C;JOHN J TORRENTE, 1133 AVENUE OF THE AMERICAS, NEW YORK, NY, 10036, US

(21) Appl. No.: 10/661,283

(22) Filed: Sep. 12, 2003

(51) Int. Cl. H01M 8/10; H01M 8/00

(52) U.S. Cl. 429/32

(57) ABSTRACT

A connection assembly for connecting first and second components so as to promote electrical isolation therebetween comprising first and second members adapted to be connected to the first and second components and a dielectric member situated between the first and second members. A fastening assembly is provided to fasten the first and second members and the dielectric member together as a unit. The fastening assembly includes dielectric elements and a dielectric coating is applied to preselected surface areas of the first and second members. The first component of the connection assembly may be at a different electrical potential than the second component.

### BACKGROUND OF THE INVENTION

This invention relates to an assembly for connecting members, and, in particular, an assembly for connecting members to promote electric isolation between them.

Assemblies for connecting members so as to maintain electrical isolation of the members are used in various applications. One particular application is in fuel cell systems, and specifically fuel cell stack assemblies.

In fuel cell stack assemblies, it is required that electrical isolation be provided for the pipe connections at the electrically live end of the fuel cell stack, and in some cases to electrically isolate the pipe connections at both ends of the fuel cell stack. More particularly, because a fuel cell stack may comprise several hundred cells connected in series, a DC voltage difference is generated between the two ends of the stack. This DC voltage difference may range from a few volts to more than 500 volts. In externally manifolded fuel cell stacks, process gases are often routed through the fuel cell stack end plates to provide heat to the heavy steel plates and to provide a more secure connection point for the process pipes. In internally manifolded fuel cell stacks, gas connections to the end plates are required.

To electrically isolate the pipes connected to the end cells of a fuel cell stack from the pipes exiting the fuel cell assembly, one practice employs ceramic cylindrical connectors to connect the pipes. In particular, commonly-assigned U.S. Pat. No. 6,410,161 discloses a ceramic to metal brazing process for use with these types of connectors.

As can be appreciated, the ceramic connectors in the '161 patent are very expensive to manufacture due to the complex processing required to braze the ceramic material to the steel pipes. Additionally, the braze connection realized may be unreliable at the high temperatures occurring during operation of some high temperature fuel cell systems. Another disadvantage of using brazed ceramic cylindrical connectors is that the high temperatures used during welding may lead to cracking.

It is therefore an object of the present invention to provide an assembly for connecting components that promotes electrical isolation between the members.

It is a further object of the invention to provide an assembly for connecting pipes in a fuel cell stack assembly which promotes electrical isolation of the pipes.

### SUMMARY OF THE INVENTION

In accordance with the principles of the present invention, the above and other objectives are realized in a connection assembly for connecting first and second components in which first and second members are adapted to be connected to the first and second components and a dielectric member is situated between the first and second members. A fastening assembly is also provided to fasten the first and second members and the dielectric member together as a unit. Preselected surface areas of the first and second members are coated with a dielectric coating and the fastening assembly is also provided with dielectric elements.

In the embodiment disclosed hereinafter, the first and second components are first and second pipes used in a fuel cell stack assembly. The first and second members are like flanges with corresponding central through openings and the dielectric member is a plate or disk like member whose periphery extends outward of the peripheries of the first and second members. The dielectric member also has a central through opening which aligns with the through openings of the first and second members and is of an extent such that the dielectric member extends into or overlays a part of the through openings of the first and second members.

The fastening assembly engages further aligned openings in the first and second members and the dielectric member and includes a dielectric tube situated in the openings through which a bolt assembly passes having dielectric washers.

A dielectric coating is applied to selective outer surfaces of the first and second members as well as to the surfaces of the openings receiving the fastening assembly.

### BRIEF DESCRIPTION OF THE DRAWINGS

The above and other features and aspects of the present invention will become more apparent upon reading the following detailed description in conjunction with the accompanying drawings, in which:

FIG. 1 shows an exploded view of a connection assembly in accordance with the principles of the present invention;

FIG. 2A shows a cross-sectional view of the connection assembly of FIG. 1;

FIG. 2B shows an exploded view of an end of the fastening assembly of the connection assembly of FIG. 2A;

FIG. 2C shows an exploded view of an interior section of the connection assembly shown in FIG. 2A;

FIG. 3 shows a fuel cell system incorporating a plurality of the connection assemblies of FIG. 1;

FIG. 4 shows a graph of relative gas sealing test results for the connection assembly of FIG. 1 using polished and unpolished sealing surfaces at different bolt torque values; and

FIG. 5 shows the connection assembly of FIG. 1 using a V-band clamp as a fastening unit.

### DETAILED DESCRIPTION

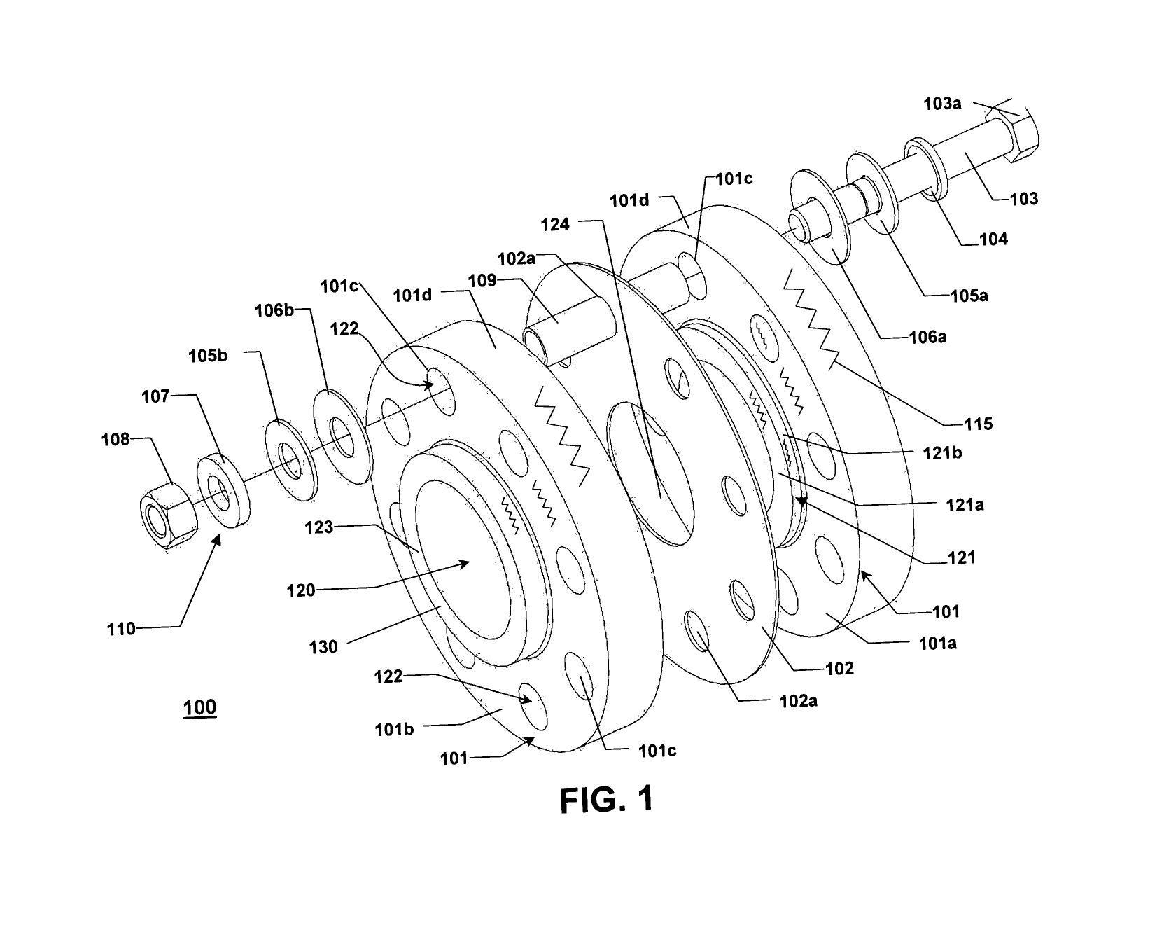

FIG. 1 illustrates an exploded view of a connection assembly 100 in accordance with the principles of the present invention. As shown, the connection assembly 100 is to be used to connect first and second components, e.g. pipes, of a fuel cell stack assembly so as to realize electrical isolation of the components. In the present illustrative case, in accord with the invention, the assembly 100 comprises two like members, shown as like metallic, disk or cylindrically shaped flange members 101, to which the components of the stack are to be connected. In further accord with the invention, the connection assembly 100 also comprises a dielectric gasket member 102, shown as a disk shaped member, positioned between the two metal flanges 101, and a fastening assembly 110 which holds the metal flanges 101 and the dielectric gasket member 102 together.

Each metal flange member 101 has on a first surface 101a a raised face 121 having surfaces 121a and 121b. The surface 121a of each raised face 121 serves as a gas sealing surface which compresses the dielectric gasket member 102. Each of the flange members 101 also has a weld-neck 123 on a second surface 101b and a through opening 120. The through opening 120 extends from the surface 101a at the raised face 121 to the surface 101b at the weld-neck 123. The pipe to be connected to each flange 101 passes into the opening 120 at the weld-neck 123 and can be welded to the inner and outer surface areas of the neck. A standard ASME slip-on style flange may be used for each of the metal flanges 101.

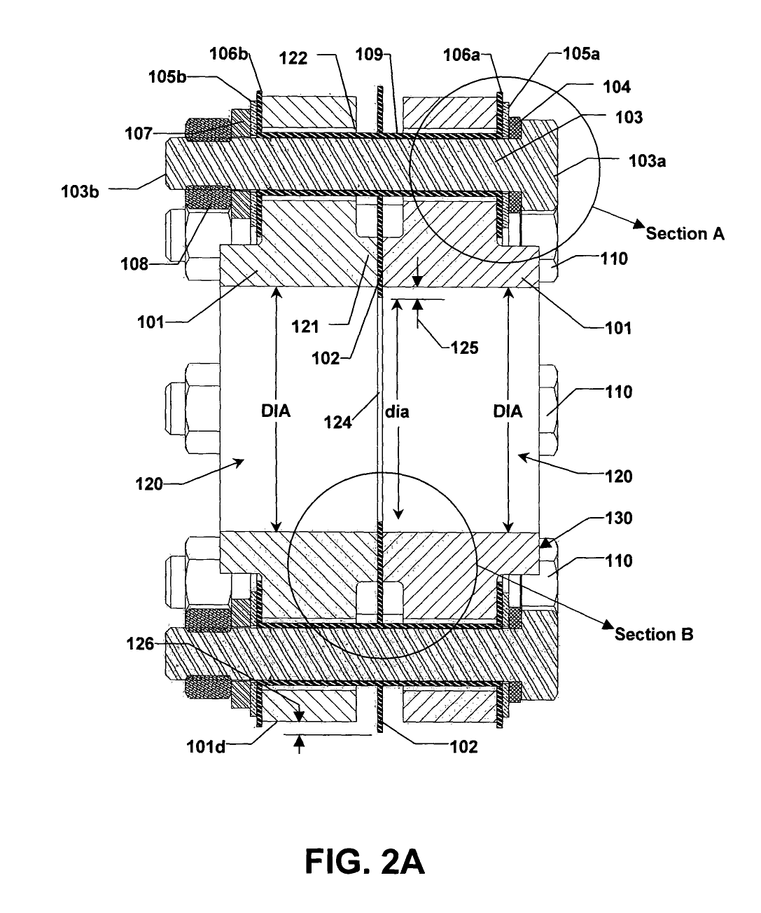

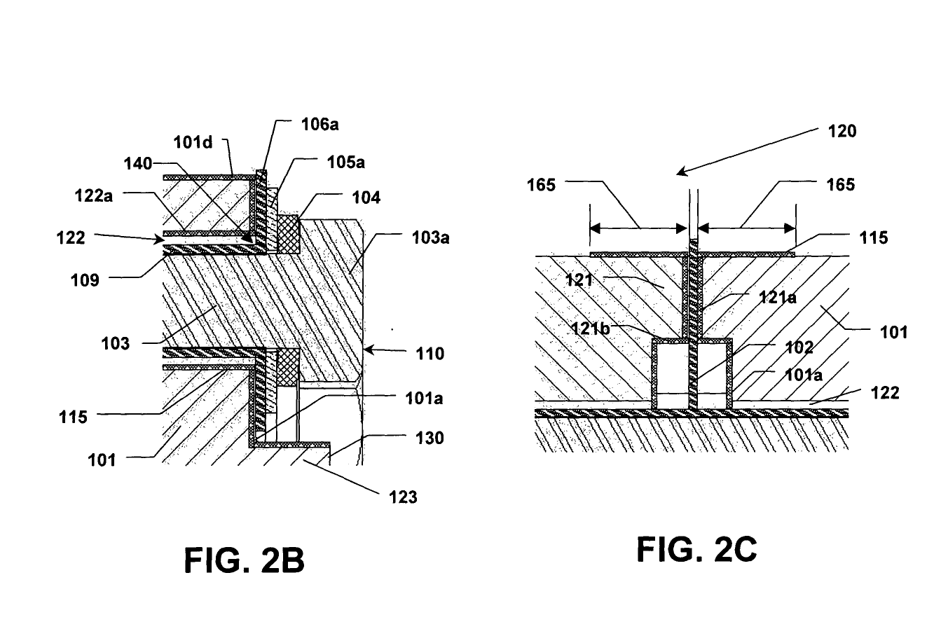

A dielectric coating 115 is provided on pre-selected surfaces of each flange member 101 as described in further detail with reference to FIGS. 2A-2C below. The dielectric coating 115 provides a secondary layer of dielectric protection for the connection assembly 100. Preferably, the dielectric coating 115 comprises a multi-layer, graded ceramic coating which remains structurally intact during thermal expansion and thermal cycling, as occurs in a fuel cell stack assembly. More preferably, the dielectric coating 115 comprises a three-layer coating including a first bond coating layer of NiCrAlY having a thickness of 0.007 inches, a second coating layer comprising a mixture of 50% NiCrAlY and 50% Al₂O₃ by weight having a thickness of 0.005 inches and a third coating layer of Al₂O₃ having a thickness of 0.015 inches. The dielectric coating 115 may be applied to the pre-selected surfaces of the respective flange member 101 by plasma spraying or any other suitable method.

The dielectric gasket member 102 of the assembly 100 functions as an electrical or dielectric isolator and as a gas seal. Typically, the gasket member 102 may comprise a dielectric material such as mica. Cogemica High-Temp 710 material manufactured by Cogebi is an example of a suitable gasket material.

As above-mentioned, each of the flange members 101 has a central through opening 120. The dielectric member 102 also has a central through opening 124. In assembled form, the through openings 120 of the members 101 and the through opening 124 of the gasket member 102 are aligned, so as to provide a passage for gas flow from one to the other of the pipes being connected by the assembly. The through opening 124 of the gasket member 102 is preferably smaller than the through opening 120 of each of the flange members 101 so that the gasket 102 extends into or overlays a part of the regions defined by the through openings 120. In this way, the gasket 102 acts as a dam preventing debris from accumulating between the inner sealing surfaces 121a of the two flange members 101 at the inner flange surfaces defining the through opening 120. In addition, the outer extent or diameter of the gasket member 102 is preferably larger than the outer extent or diameter of each of the flange members 101 so as to create a similar barrier protecting against debris accumulation at the abutting outer surfaces 101d of the flange members 101.

Each of the flange members 101 also includes one or more apertures 101c offset from the through opening 120. Similarly, the gasket member 102 includes one or more apertures 102a offset from the opening 124. In assembled state, corresponding apertures 101c of the members 101 align with a corresponding aperture 102a in the gasket 102 to form a through opening 122 adapted to receive one or more of the fastening units 110 of a fastening assembly of the connection assembly 100.

In FIG. 1, one fastening unit 110 is shown in exploded view. However, several fastening units 110 are actually used, and five such units are shown in the cross-sectional view of FIG. 2A.

As shown, the fastening unit 110 has a dielectric tube 109 and a metal bolt 103. A metal flat washer 105a, a metal spring washer 104 and a dielectric flat washer 106a are situated at the head end 103a of the bolt 103. A metal hex nut 108, a metal thick washer 107, a metal flat washer 105b and a dielectric flat washer 106b are situated at the threaded end 103b of the bolt 103.

As can be seen, the dielectric tube 109 is inserted into the through opening 122. The spring washer 104, the metal flat washer 105a and the dielectric flat washer 106a are placed at the head end 103a of the metal bolt 103, and the threaded end 103b of the bolt 103 is inserted into and through the dielectric tube 109. The dielectric flat washer 106b, the metal flat washer 105b and the thick washer 107 are placed on the threaded end 103b of the metal bolt 103 as shown in FIG. 1, and the fastening unit 110 is secured with the hex nut 108.

As can be appreciated, the metal members of the fastening unit 110 must be in electrical isolation from the metal flange members 101 to preserve the electrical isolation which results from the presence of the dielectric member 102. The dielectric tube 109 and the dielectric flat washers 106a, 106b, which also may be made from mica or any other suitable electrically insulating material, provide this electrical isolation, as described in more detail below with reference to FIGS. 2A-2C.

The fastening assembly having the units 110, as shown in the figures, is illustrative of a typical fastening assembly which may be used to fasten the flange members 101 and the dielectric member 102 together. It is within the contemplation of the invention that the components of the fastening assembly and their arrangement may be varied as required by the connection assembly 100 and the particular application. For example, the spring washer 104 need not be employed, but has been included in the particular fuel cell application discussed to provide additional follow-up during thermal expansion and cycling of the fuel cell stack assembly, as well as to prevent overstressing the bolt 103.

Also, as above-mentioned, in practice, a plurality of fastening units 110 will be employed. The number of fastening units 110 to be used, of course, will depend, amongst other things, on the size of the connection assembly 100.

FIG. 2A shows a cross-sectional view of the connection assembly 100 of FIG. 1. As previously discussed and seen more clearly in this view, the metal flanges 101 are separated at their raised faces 121 by the dielectric gasket 102, thereby providing electrical isolation and a gas seal between the two flange members 101. As also previously discussed, the diameter dia of the through opening 124 of the dielectric gasket member 102 is smaller than the diameter DIA of the through openings 120 of the metal flange members 101. This can be seen in FIG. 2A and results in the dielectric gasket member 102 extending into or overlapping a part of the regions of the through openings 120 by a predetermined distance 125. Similarly, the outer extent or diameter of the dielectric gasket member 102 is greater than the outer extent or diameter of each of the metal flange members 101, whereby the dielectric gasket 102 extends outwardly past the outer surface 101d of each of the metal flange members 101 by a predetermined distance 126. As a result of these extensions, dielectric barriers are created which prevent debris from accumulating on the inner and outer surfaces of the flange members 101, thus preserving the dielectric or electrical isolation between the metal flanges.

As discussed above, the dielectric flat washers 106a, 106b and the dielectric tube 109 function to electrically isolate the metallic components of a fastening unit 110 from the metal flange members 101. As can be seen in FIG. 2A, the dielectric tube 109 extends along the length of the through opening 122 of the connection assembly 100, thereby electrically isolating the metal bolt 103 from the metal flange members 101. Additionally, the dielectric flat washers 106a, 106b act to electrically isolate the remaining metallic components (i.e., the flat washers 105a, 105b, the thick washer 107, the spring washer 104 and the nut 108) of the fastening unit 110 from the metal flanges 101.

FIG. 2B shows an exploded view of an encircled section A of FIG. 2A at the head end 103a of the bolt 103. Although not readily visible, the dielectric tube 109 protrudes slightly into the aperture of the dielectric flat washer 106a at the location 140 to provide a continuous dielectric layer separating the metal components of the fastening unit 110 from the flange members 101 and to avoid any possible breaks in dielectric isolation. In addition, dielectric coating 115 is applied to the exterior surfaces 101d and 101a of the flange members 101 and to the surface 122a of the through opening 122 to provide a secondary dielectric or electrical isolation layer. Dielectric coating 115, however, is not applied to the outer surface 130 of the weld-neck 123 portion of the flange members 101 so as not to interfere with the welding of the pipes to the flange members.

FIG. 2C illustrates an exploded view of an encircled section B of FIG. 2a. This view shows in greater detail application of dielectric coating 115 to the inner surfaces that form the through openings 120 and to the raised faces 121 in contact with the dielectric gasket member 102. As can be seen in FIG. 2C, dielectric coating 115 is applied to the surfaces 101a of the flange members 101 as well as to the surfaces 121a, 121b of the raised faces 121 of the flange members 101 so as to provide additional electric isolation between the flange members 101. Moreover, the dielectric coating 115 further extends for a short distance 165 from the surface 121a of the raised face 121 of each of the flange members 101 onto the surface of the through opening 120. The coating 115 on the surface of the through opening 120 of each flange member 101 provides further protection against debris in the pipe the accumulation of which may compromise the electrical isolation between the flange members 101.

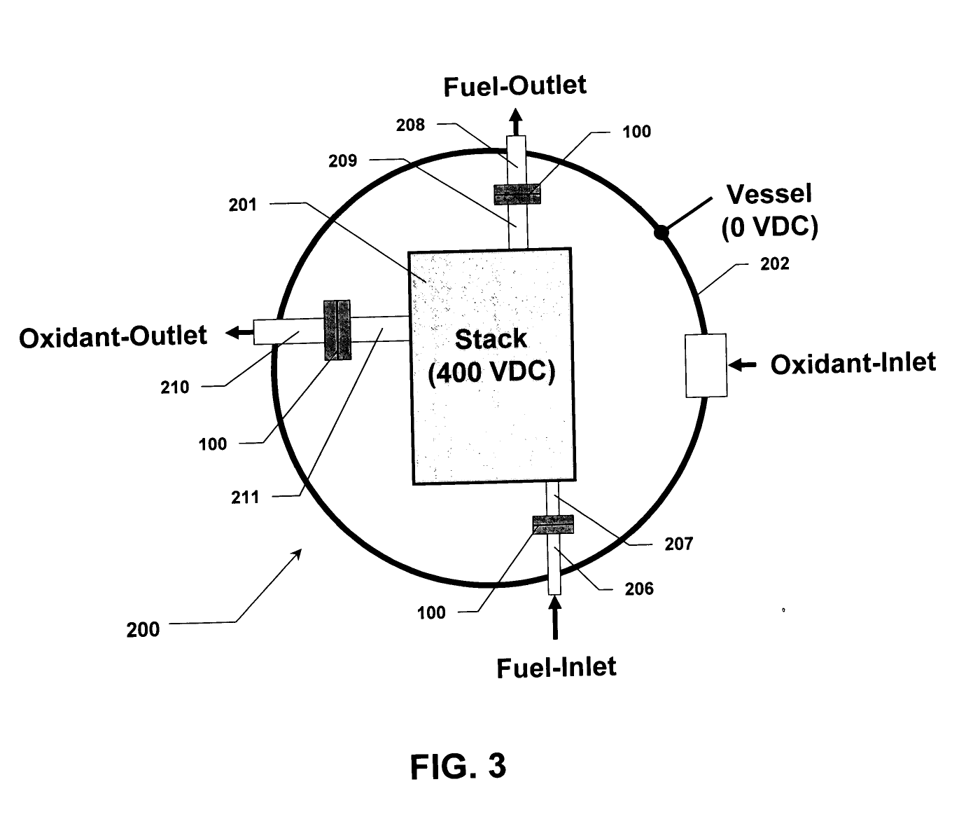

FIG. 3 shows use of a number of connection assemblies 100 employed in a fuel cell stack assembly 200. The fuel cell stack assembly 200 comprises a fuel cell stack 201 enclosed inside a vessel 202. The fuel cell assembly 200 further comprises internally manifolded process gas pipes or connections 207, 209 and 211 for fuel process gas delivery, fuel exhaust gas removal and oxidant exhaust gas removal, respectively, connected to the fuel cell stack 201. The process gas pipes 207, 209 and 211 are at a higher electrical potential than the vessel 202. In the case shown, the electrical DC potential of the process gas pipes 207, 209 and 211 may be as high as 400 Volts when compared to the electrical potential of 0 Volts DC of the vessel 202. Further process gas pipes 206, 208 and 210 passing through the vessel 202 are at the same electrical potential of 0 Volts DC as the vessel 202. The vessel process gas pipes 206, 208 and 210 are to be connected to their corresponding fuel cell stack process gas pipes 207, 209 and 211 having an electrical potential of 400 Volts DC.

Dielectric isolation between the fuel cell stack pipes 207, 209 and 211 and the vessel pipes 206, 208 and 210, respectively, is accomplished by using connection assemblies 100 sized to accommodate the pipes being connected. In this way, each of the connection assemblies 100 joins each of the fuel cell stack process gas pipes 207, 209 and 211 to its respective vessel process gas pipe 206, 208 and 210 without disturbing the electrical potential of each of the pipes.

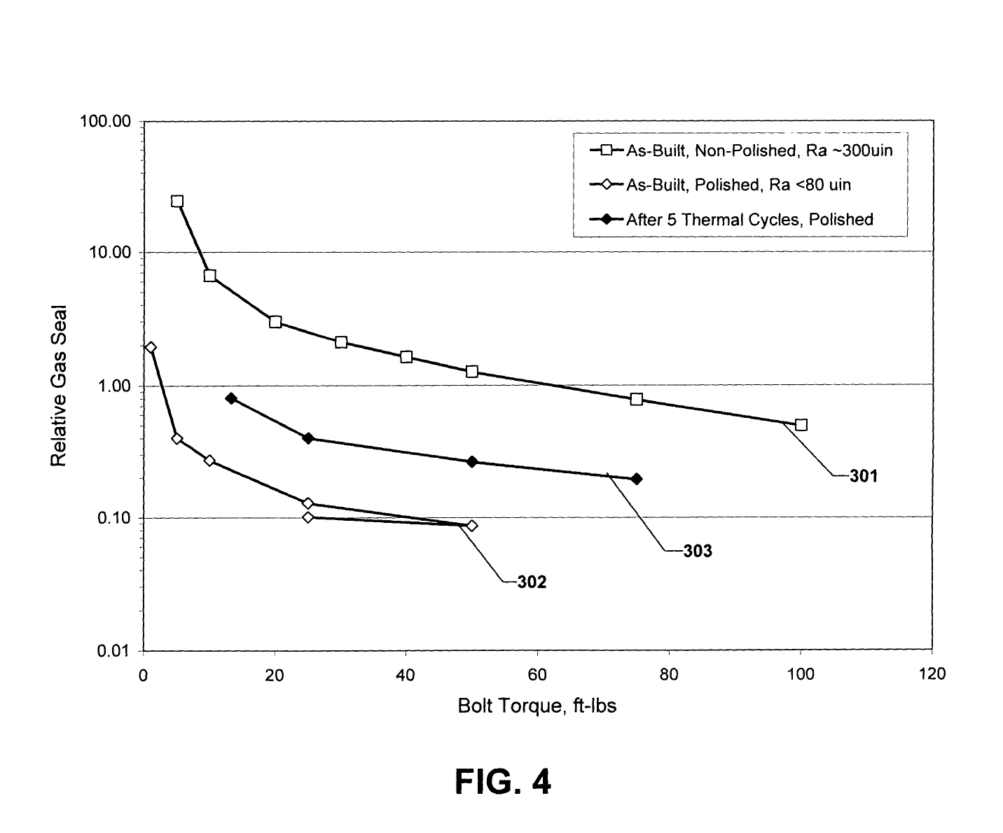

The gas sealing capability of the connection assembly 100 of the invention was tested for assemblies having different surface roughness of the surfaces 121a of the raised faces 121 of the metal flange members 101. The testing was performed under conditions simulating a fuel cell stack assembly and the connection assemblies were used to connect pipes in the manner shown in FIG. 3. FIG. 4 shows a graph of relative gas sealing test results for the connection assemblies 100 with the different surface roughnesses and at different bolt torque values. The X-axis in FIG. 4 represents the bolt torque in ft-lb corresponding to the amount of force used to hold the flange members 101 and the dielectric gasket member 102 together. The Y-axis represents the relative gas seal which is directly related to the amount of gas escaping through the connection assembly 100.

As shown in FIG. 4, the first curve 301 corresponds to a connection assembly 100 having surfaces 121a in the as-coated condition with an approximately 300 μin surface roughness. The second curve 302 corresponds to a connection assembly having polished flange surfaces 121a with a surface roughness equal to approximately 80 μin, and the third curve 303 corresponds to a connection assembly having a polished surface 121a after undergoing five thermal cycles between room temperature and the fuel cell operating temperature of 600° Celsius. As can be appreciated, the gas sealing characteristics of the connection assembly 100 improved if the sealing surface 121a was polished as compared to connection assemblies having non-polished as-coated sealing surfaces. Additionally, it can be seen that the gas sealing decreases as the connection assembly 100 undergoes several thermal cycles. However, even after five thermal cycles, the connection assembly 100 having polished sealing surfaces 121a had better gas sealing characteristics than the connection assembly 100 having non-polished sealing surfaces 121a. Moreover, as shown in FIG. 4, the relative gas sealing characteristics of the connection assembly 100 improve with an increase in the bolt torque.

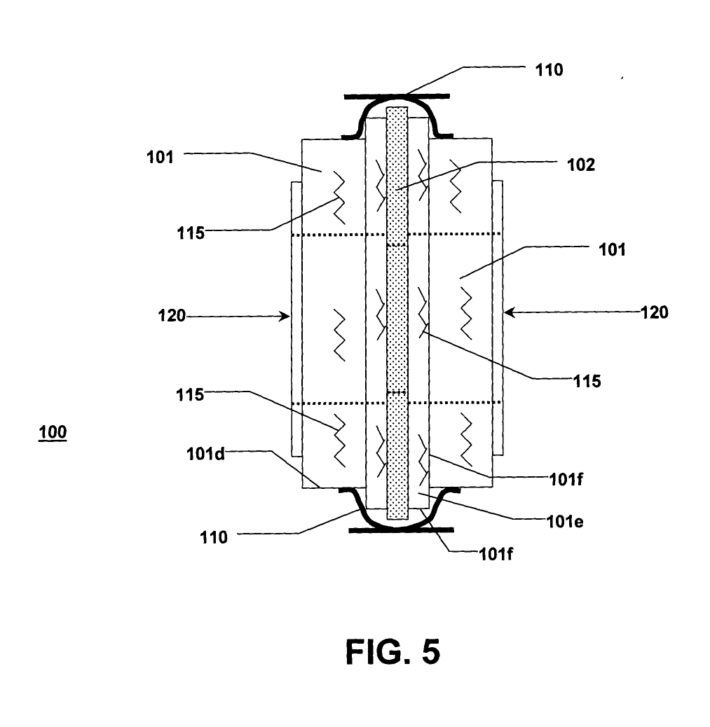

Another embodiment of the connection assembly 100 described above is shown in FIG. 5. In this embodiment, the connection assembly 100 includes a V-band clamp as a fastening unit 110.

As previously discussed and as shown in FIG. 5, the metal flange members 101 are separated by a dielectric gasket 102. Also as previously discussed, each of the metal flanges 101 and the dielectric gasket 102 include a through opening (shown in dotted line) aligned so as to provide a passage for the flow of gas. In this embodiment, each of the flanges 101 includes a raised exterior portion 101e which allows the fastening unit 110, or the V-band clamp, to fasten the flange members 101 and the dielectric member 102 together. With this case, through openings for the fastening unit are not required in the flange members 101 and the dielectric gasket 102. As shown, the V-band clamp 110 fastens the flange members 101 and the dielectric member 102 together by clamping around the raised exterior portions 101e of the flanges 101 and the dielectric member 102.

As previously described, dielectric coating 115 is applied to the exterior surfaces of the flange members 101. More specifically and as shown in FIG. 5, dielectric coating 115 is applied to the exterior surfaces 101d and raised exterior surfaces 101f of the raised exterior portion 101e so as to promote electrical isolation between the V-band clamp 110 and the metallic flange members 101. Additional dielectric materials or layers may be used between the V-band clamp 110 and the flange members 101 to provide further electrical isolation between the flange members 101.

In all cases it is understood that the above-described arrangements are merely illustrative of the many possible specific embodiments which represent applications of the present invention. Numerous and varied other arrangements can be readily devised in accordance with the principles of the present invention without departing from the spirit and the scope of the inventions. Thus, for example, the invention is applicable to other types of conventional fastening assemblies or clamps, such as for example, standard T-Band clamps, which can be suitably adapted to include a dielectric member between the clamp flanges and a dielectric coating on preselected surfaces of the flanges.

1. A connection assembly for connecting first and second components so as to promote electrical isolation therebetween comprising first and second members adapted to be connected to said first and second components and a dielectric member situated between said first and second members.

2. A connection assembly in accordance with claim 1, wherein said first component is at a first electrical potential and wherein said second component is at a second electrical potential.

3. A connection assembly in accordance with claim 2, wherein said first component is a pipe and said second component is a pipe.

4. A connection assembly in accordance with claim 1, wherein each of said first and second members includes a through opening and said dielectric member includes a through opening, said through openings of said first and second members and said dielectric member being such as to allow passage through the through opening of one of the first and second members, through the through opening of the dielectric member, and then through the through opening of the other of the first and second members.

5. A connection assembly in accordance with claim 4, wherein the through opening of said dielectric member is smaller than the through openings of said first and second members, whereby a part of the dielectric member overlaps the region of the through opening of said first member and a part of the dielectric member overlaps the region of the through opening of the second member.

6. A connection assembly in accordance with claim 5, wherein the outer extent of the dielectric member extends outward of the outer extent of the first member and outward of the outer extent of the second member.

7. A connection assembly in accordance with claim 6, wherein: each of said first and second members has first and second opposing surfaces, an outer surface connecting the outer peripheries of said first and second opposing surfaces, and the through opening of each of said first and second members extends between the first and second surfaces of that member; said dielectric member has first and second surfaces and the through opening of said dielectric member extends between the first and second surfaces of the dielectric member; and the first surface of said dielectric member faces the first surface of one of said first and second members and the second surface of said dielectric member faces the first surface of the other of said first and second members.

8. A connection assembly in accordance with claim 7, wherein the first surface of each of said first and second members includes a raised sealing face outward of the through opening of that member; and the first surface of said dielectric member outward of the through opening of the dielectric member abuts a part of the raised sealing face on the first surface of said one of said first and second members and the second surface of the dielectric member outward of the through opening of the dielectric member abuts a part of the raised sealing face on the first surface of the other of said first and second members.

9. A connection assembly in accordance with claim 8, wherein said parts of said raised sealing faces of said first surfaces of said first and second members are coated with a dielectric coating.

10. A connection assembly in accordance with claim 9, wherein said coating on said parts of said raised sealing faces of said first surfaces of said first and second members is polished.

11. A connection assembly in accordance with 9, wherein the through opening of each of said first and second members is coated with a dielectric material starting at a location adjacent said first surface of that member and ending at a second location which is a preselected distance from said first location and short of said second surface of that member.

12. A connection assembly in accordance with claim 11, wherein the first surface of each of said first and second members is coated with a dielectric material.

13. A connection assembly in accordance with claim 12, wherein the outer surface of each of said first and second members is coated with a dielectric material.

14. A connection assembly in accordance with claim 8, wherein each of said first and second members includes a weld-neck on the second surface of that member outward of the through opening of that member.

15. A connection assembly in accordance with claim 14, wherein the second surface of each of said first and second members is coated with a dielectric material short of a part of the weld neck of that surface adjacent the through opening of that member.

16. A connection assembly in accordance with claim 15, wherein: said parts of said raised sealing faces of said first surfaces of said first and second members are coated with a dielectric coating; the through opening of each of said first and second members is coated with a dielectric material starting at a location adjacent said first surface of that member and ending at a second location which is a preselected distance from said first location and short of said second surface of that member; the first surface of each of said first and second members is coated with a dielectric material; and the outer surface of each of said first and second members is coated with a dielectric material.

17. A connection assembly in accordance with claim 16, wherein each of said first and second members is cylindrical in shape, said dielectric member is disk shaped, said through openings of said first and second members are centrally disposed and circular in cross section, and the through opening of said dielectric member is centrally disposed, aligned with the through openings of said first and second members and of circular cross section less than the circular cross section of said through openings of said first and second members.

18. A connection assembly in accordance with claim 17, wherein said first and second members are each a like flange.

19. A connection assembly in accordance with claim 18, wherein each of said first and second members is an ASME slip-on flange.

20. A connection assembly in accordance with claim 16, wherein: said dielectric member comprises a mica material; and said dielectric coating comprises a multi-layer graded ceramic coating.

21. A connection assembly in accordance with claim 18, wherein said dielectric coating comprises a first layer comprising NiCrAlY, a second layer comprising a mixture of NiCrAlY and Al₂O₃ and a third layer comprising Al₂O₃.

22. A connection assembly in accordance with claim 14, further comprising a fastening assembly for fastening said first and second members and said dielectric member together as a unit.

23. A connection assembly in accordance with claim 21, wherein parts of said fastening assembly include a dielectric material.

24. A connection assembly in accordance with claim 22, wherein: each of said first and second members has one or more a second through openings extending from the first surface to the second surface of that member; said dielectric member includes one or more second through openings extending from the first surface to the second surface of the dielectric member; each of the second through openings in said first member has a corresponding second through opening in said second member and the corresponding through openings in said first and second members align with a second through opening in said dielectric member; and said fastening assembly includes one or more fastening units, each of said fastening units coupling with corresponding second through openings in the first and second members and the aligned second through opening in said dielectric member.

25. A connection assembly in accordance with claim 24, wherein each of said fastening units includes a dielectric tube extending through the corresponding second through openings in the first and second members and the aligned second through opening in said dielectric member coupling with that fastening unit.

26. A connection assembly in accordance with claim 25, wherein each of said fastening units further includes a bolt, a first dielectric washer, a second dielectric washer, and a securing member for securing said bolt.

27. A connection assembly in accordance with claim 26, wherein for each of the fastening units: the bolt passes through the dielectric tube; the first dielectric washer is located at the head end of the bolt adjacent the second surface of one of said first and second members; and the second dielectric washer is located at the threaded end of the bolt adjacent the second surface of the other of said first and second members.

28. A connection assembly in accordance with claim 27, wherein for each of the fastening units the dielectric tube protrudes into the through opening in each of said first and second dielectric washers.

29. A connection assembly in accordance with claim 28, wherein each of the fastening units further comprises: at least one metallic washer located at the head end of the bolt of that fastening unit outward of the first dielectric washer of that fastening unit; at least one metallic washer located at the threaded end of the bolt of that fastening unit outward of the second dielectric washer of that fastening unit.

30. A connection assembly in accordance with claim 28, wherein: said parts of said raised sealing faces of said first surfaces of said first and second members are coated with a dielectric coating; the through opening of each of said first and second members is coated with a dielectric material starting at a location adjacent said first surface of that member and ending at a second location which is a preselected distance from said first location and short of said second surface of that member; the first surface of each of said first and second members is coated with a dielectric material; the outer surface of each of said first and second members is coated with a dielectric material; the second surface of each of said first and second members is coated with a dielectric material short of a part of the weld neck of that surface adjacent the through opening of that member; and said second through openings of said first and second members are coated with a dielectric material.

31. A connection assembly in accordance with claim 30, wherein each of said first and second members is cylindrical in shape, said dielectric member is disk shaped, said through openings of said first and second members are centrally disposed and circular in cross section, and the through opening of said dielectric member is centrally disposed, aligned with the through openings of said first and second members and of circular cross section less than the circular cross section of said through openings of said first and second members.

32. A connection assembly in accordance with claim 31, wherein: said dielectric member comprises a mica material; and said dielectric coating comprises a multi-layer graded ceramic coating.

33. A connection assembly in accordance with claim 14, wherein said fastening assembly comprises a V-band clamp.

34. A connection assembly in accordance with claim 1, further comprising a fastening assembly for fastening said first and second members and said dielectric member together as a unit.

35. A connection assembly in accordance with claim 34 wherein said fastening assembly comprises one of a bolt assembly and a V-band clamp.

36. A connection assembly in accordance with claim 34, wherein preselected parts of said first and second members are coated with a dielectric material and preselected parts of said connection assembly comprise a dielectric material.

37. A fuel cell stack assembly comprising:
a fuel cell stack;
at least a first pipe connected to said fuel-cell stack;
a second pipe; and
a connection assembly for connecting said first and second pipes so as to promote electrical isolation therebetween comprising: first and second members connected to said first and second pipes and a dielectric member situated between said first and second members.

38. A fuel-cell stack assembly in accordance with claim 37, wherein each of said first and second members includes a through opening and said dielectric member includes a through opening, said through openings of said first and second members and said dielectric member being such as to allow passage through the through opening of one of the first and second members, through the through opening of the dielectric member, and then through the through opening of the other of the first and second members.

39. A fuel-cell stack assembly in accordance with claim 38, wherein the through opening of said dielectric member is smaller than the through openings of said first and second members, whereby a part of the dielectric member overlaps the region of the through opening of said first member and a part of the dielectric member overlaps the region of the through opening of the second member.

40. A fuel-cell stack assembly in accordance with claim 39, wherein the outer extent of the dielectric member extends outward of the outer extent of the first member and outward of the outer extent of the second member.

41. A fuel-cell stack assembly in accordance with claim 40, wherein: each of said first and second members has first and second opposing surfaces, an outer surface connecting the outer peripheries of said first and second opposing surfaces, and the through opening of each of said first and second members extends between the first and second surfaces of that member; said dielectric member has first and second surfaces and the through opening of said dielectric member extends between the first and second surfaces of the dielectric member; and the first surface of said dielectric member faces the first surface of one of said first and second members and the second surface of said dielectric member faces the first surface of the other of said first and second members.

42. A fuel-cell stack assembly in accordance with claim 41, wherein the first surface of each of said first and second members includes a raised sealing face outward of the through opening of that member; and the first surface of said dielectric member outward of the through opening of the dielectric member abuts a part of the raised sealing face on the first surface of said one of said first and second members and the second surface of the dielectric member outward of the through opening of the dielectric member abuts a part of the raised sealing face on the first surface of the other of said first and second members.

43. A fuel-cell stack assembly in accordance with claim 42, wherein each of said first and second members includes a weld-neck on the second surface of that member outward of the through opening of that member.

44. A fuel-cell stack assembly in accordance with claim 43, wherein said connection assembly further comprises a fastening assembly for fastening said first and second members and said dielectric member together as a unit.

45. A fuel-cell stack assembly in accordance with claim 44, wherein: each of said first and second members has one or more a second through openings extending from the first surface to the second surface of that member; said dielectric member includes one or more second through openings extending from the first surface to the second surface of the dielectric member; each of the second through openings in said first member has a corresponding second through opening in said second member and the corresponding through openings in said first and second members align with a second through opening in said dielectric member; and said fastening assembly includes one or more fastening units, each of said fastening units having a dielectric tube extending through corresponding second through openings in the first and second members and the aligned second through opening in said dielectric member.

46. A fuel-cell stack assembly in accordance with claim 45, wherein:
each of said fastening units further includes a bolt, a first dielectric washer, a second dielectric washer, and a securing member for securing said bolt; and
wherein for each of the fastening units: the bolt passes through the dielectric tube; the first dielectric washer is located at the head end of the bolt adjacent the second surface of one of said first and second members; and the second dielectric washer is located at the threaded end of the bolt adjacent the second surface of the other of said first and second members.

47. A fuel-cell stack assembly in accordance with claim 46, wherein for each of the fastening units the dielectric tube protrudes into the through opening in each of said first and second dielectric washers.

48. A fuel-cell stack assembly in accordance with claim 47, wherein each of the fastening units further comprises: at least one metallic washer located at the head end of the bolt of that fastening unit outward of the first dielectric washer of that fastening unit; at least one metallic washer located at the threaded end of the bolt of that fastening unit outward of the second dielectric washer of that fastening unit.

49. A fuel-cell stack assembly in accordance with claim 46, wherein: said parts of said raised sealing faces of said first surfaces of said first and second members are coated with a dielectric coating; the through opening of each of said first and second members is coated with a dielectric material starting at a location adjacent said first surface of that member and ending at a second location which is a preselected distance from said first location and short of said second surface of that member; the first surface of each of said first and second members is coated with a dielectric material; the outer surface of each of said first and second members is coated with a dielectric material; the second surface of each of said first and second members is coated with a dielectric material short of a part of the weld neck of that surface adjacent the through opening of that member; and said second through openings of said first and second members are coated with a dielectric material.

50. A fuel-cell stack assembly in accordance with claim 49, wherein each of said first and second members is cylindrical in shape, said dielectric member is disk shaped, said through openings of said first and second members are centrally disposed and circular in cross section, and the through opening of said dielectric member is centrally disposed, aligned with the through openings of said first and second members and of circular cross section less than the circular cross section of said through openings of said first and second members.

51. A fuel-cell stack assembly in accordance with claim 50, wherein said first and second members are each a like flange.

52. A fuel-cell stack assembly in accordance with claim 51, wherein each of said first and second members is an ASME slip-on flange.

53. A fuel-cell stack assembly in accordance with claim 48, wherein: said dielectric member comprises a mica material; and said dielectric coating comprises a multi-layer graded ceramic coating.

54. A fuel cell stack assembly in accordance with claim 53, wherein said dielectric coating comprises a first layer comprising NiCrAlY, a second layer comprising a mixture of NiCrAlY and Al₂O₃ and a third layer comprising Al₂O₃.

55. A fuel cell stack assembly in accordance with claim 49, wherein said coating on said parts of said raised sealing faces of said first surfaces of said first and second members is polished.

56. A fuel cell stack assembly in accordance with claim 44, wherein said fastening assembly comprises a V-band clamp.

57. A fuel cell stack assembly in accordance with claim 37, further comprising a vessel surrounding said fuel cell stack and through which said second pipe extends.

58. A fuel cell stack assembly in accordance with claim 37, further comprising a fastening assembly for fastening said first and second members and said dielectric member together as a unit.

59. A fuel cell stack assembly in accordance with claim 58, wherein said fastening assembly comprises one of a bolt assembly and a V-band clamp.

60. A fuel cell stack assembly in accordance with claim 59, wherein preselected parts of said first and second members are coated with a dielectric material and preselected parts of said connection assembly comprise a dielectric material.
